(19) United States
(12) Patent Application Publication
(10) Pub. No.: US 2024/0251988 A1
(43) Pub. Date: Aug. 1, 2024

(54) APPARATUS AND METHOD FOR COOKING FOOD USING ALCOHOL, WITHOUT CONTACT

(71) Applicant: COOKAL SAS, MAXEVILLE (FR)

(72) Inventor: Laurent PROBST, ALFORTVILLE (FR)

(21) Appl. No.: 18/561,146

(22) PCT Filed: Apr. 21, 2022
(86) PCT No.: PCT/EP2022/060521

§ 371 Date: Nov. 15, 2023

(30) Foreign Application Priority Data
May 20, 2021 (FR) FR2105254

(51) Int. Cl. A47J 36/26; A23L 5/10

(52) U.S. Cl. CPC A47J 36/26; A23L 5/10

(57) ABSTRACT

The present invention relates to an appliance for cooking or heating food (1) comprising a container (2) intended to receive the said food (1), a reservoir (3) arranged under the said container (2) and able to receive a combustion liquid (4), and a holding support (5) for holding said container and reservoir, said container comprising a bottom (6) and at least one side wall (7), characterized in that the thickness of the bottom (6) measured at the center of the bottom (6) is at least twice as great as the smallest thickness measured on the wall (7). The present invention also relates to a method of cooking or heating a foodstuff by means of an appliance according to the invention.

### CROSS-REFERENCE TO RELATED PATENT APPLICATIONS

This application is a U.S. National Stage Application under 35 U.S.C. § 371 of International Patent Application No. PCT/EP2022/060521 filed Apr. 21, 2022, which claims the benefit of priority of French Patent Application number 2105254 filed May 20, 2021, both of which are incorporated by reference in their entireties. The International Application was published on Nov. 24, 2022, as International Publication No. WO/2022/242983

The invention relates to the field of food cooking. More particularly, it concerns an apparatus and process for cooking with alcohol, preferably adapted to make cooking a spectacle before tasting.

A number of alcohol-cooking appliances and processes have been proposed. There are a number of issues to be taken into account when cooking with alcohol.

The first problem concerns the alcohol used. To enable controlled cooking, it is necessary to define a precise quantity of alcohol that must be consumed to release the heat required for cooking. In some prior art processes, an alcohol is ignited, but after a certain time the flame is extinguished because the residual alcohol is too diluted in the water. In other processes, the heat released is not properly directed towards the food to be cooked. In still other processes, safety is not properly ensured, and if the appliance falls over, ignited alcohol can spill out and cause damage.

Document FR 2 897 521 describes a food cooking or heating appliance of the type comprising a support on which rests a reservoir suitable for receiving a combustion liquid, said support being suitable for holding a container at a predetermined height relative to the reservoir. However, this appliance does not provide reliable cooking, as too much of the heat produced is dissipated.

FR 3 004 095 describes a cooking appliance that makes better use of heat. However, the risks associated with ignited alcohol in the event of the appliance falling are not ruled out. In addition, the visible support of the container spoils the view of the food being cooked.

Document FR 3 029 094 describes a cooking appliance that allows a better view of the food being cooked. However, cooking is not evenly distributed in the container.

The present invention is intended to remedy at least some of the above-mentioned drawbacks, and offers a solution which makes it possible to obtain homogeneous cooking of a food item placed in a container by the combustion of an alcohol placed in a reservoir outside said container.

A further object of the present invention is to provide a device that allows a clear view of the cooking in progress.

Another object of the present invention is to provide a device for improved safety.

Another object of the present invention is to propose a cooking process that allows good control of the quantity of alcohol used, while improving safety of use.

The object of the present invention is to respond at least in part to the aforementioned objects by proposing an appliance comprising a container for disposing a foodstuff therein and a reservoir for disposing a combustible liquid therein. To this end, it proposes an appliance for cooking or heating foodstuffs, comprising a container designed to receive said foodstuff, a reservoir disposed beneath said container and designed to receive a combustion liquid, and a holding support for holding said container and reservoir, said container comprising a bottom and at least one side wall, characterized in that the thickness of the bottom measured at the center of the bottom is at least twice as great as the smallest thickness measured on the wall.

Thanks to these arrangements, the food can be cooked or heated with heat distributed more evenly throughout the container in which it is placed.

According to further features:
the thickness of the bottom measured at the center of the bottom can be greater than or equal to 6 mm, typically equal to 9 mm, and the smallest thickness measured on the wall can be between 2 and 4 mm, typically equal to 3 mm, which constitutes a simple and robust implementation of the invention,
said container may comprise at least one shoulder, and said holding support comprises at least one bearing surface of at least one of said at least one shoulder, which is a simple way of holding the container stably in a precise position relative to the reservoir,
said holding support can comprise at least two upwardly extending support elements, each support element comprising at least one of said at least one bearing surface, said holding support comprising a free space between the two support elements configured so as to make said container visible over its entire height, the container being preferably transparent, which allows good stability of the container and a possibility of making the cooking of the food a spectacle for the guests,
said at least two support elements can be tilted upwards towards the inside of the appliance, thereby directing flames resulting from combustion of the combustion liquid in the reservoir towards a side wall of the container, and optimizing the use of the heat released by combustion of the combustion liquid,
the reservoir can be wider than it is deep, so that the combustion liquid can be ignited over a large surface area, resulting in more uniform cooking of the food,
the reservoir can have a protrusion extending upwards from the bottom of the reservoir, which is a simple means of metering the amount of combustion liquid disposed therein,
the reservoir can be attached to the holding bracket by at least one arm, and at least one of the said at least one arms comprises a chute whose bottom is inclined towards the reservoir, enabling the reservoir to be easily filled with combustion liquid when direct access is not readily available,
said combustion liquid can be an ethanol with a percentage of between 85% and 99%, said ethanol comprising a Hydroxy-Alkyl-Cellulose, the dosage of Hydroxy-Alkyl-Cellulose being limited so as to obtain a dynamic viscosity of less than 100 Pa-s, which makes it possible to have a combustion liquid that is easily flammable and consumes completely, and sufficiently viscous to avoid splashing.

The present invention also relates to a method of cooking or heating a foodstuff by means of an apparatus according to the invention, comprising the following steps:
placing food in the container,
positioning the container on the holding support,
pouring combustion fluid into the reservoir,
these first three steps being carried out in any order,
ignition of the combustion liquid,
cooking or heating food

Thanks to these arrangements, the food can be cooked or heated with heat distributed more evenly over the bottom of the container in which it is placed.

The present invention will be better understood on reading the detailed description that follows, with reference to the appended figures in which:

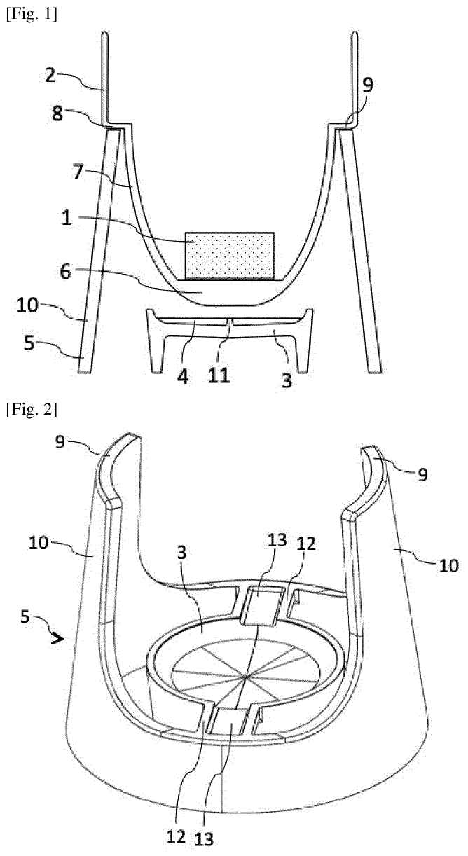

FIG. 1 is a vertical cross-sectional view of the device according to a preferred embodiment of the invention,

FIG. 2 is a perspective view of the reservoir and holding bracket of the device shown in FIG. 1.

The appliance shown in FIGS. 1 to 2 can be used to cook or heat a food product 1. The appliance comprises a container 2, designed to receive the food product during cooking or heating, and a reservoir 3 located under the container 2 and designed to receive a combustion liquid 4. Finally, the appliance includes a holding support 5 for holding the respective positions of container 2 and reservoir 3.

The container 2 has a bottom 6 and at least one side wall 7. The thickness of the bottom 6, measured at the center of the bottom 6, is at least twice as great as the smallest thickness measured on the wall 7. As the reservoir 3 is preferably placed under the bottom 6, this thickness provides mechanical reinforcement to ensure that the bottom 6 withstands the flame produced by the combustion of the liquid 4. In addition, placing a thick bottom 6 between the flame and the food 1 ensures better heat distribution over the entire bottom 6 and therefore more even cooking of the food 1. The thickness of the bottom 6 measured at its center is preferably greater than or equal to 6 mm, for example 9 mm. The smallest thickness of wall 7 is preferably between 2 and 4 mm, for example 3 mm.

The container 2 is preferably transparent, so that the cooking of a food item 1 can be observed. The container 2 can, for example, be made of a glass with a low coefficient of expansion, such as borosilicate glass known under the brand name Pyrex (registered trademark), so as to withstand the temperature changes caused by cooking.

In order to hold the container 2 above the reservoir 3, the container 2 may comprise at least one shoulder 8, suitable for resting on a bearing surface 9 of said holding support 5.

The holding support 5 can be made of cast iron, ceramic or any other heat-resistant material. It may comprise at least two upwardly extending support elements 10. Each support element 10 has a bearing surface 9 on which the shoulder 8 rests. Container 2 may comprise a single shoulder 8, two sections of which each bear on one of the bearing surfaces 9. Alternatively, container 2 may comprise a plurality of shoulders 8, each shoulder 8 resting on one of the bearing surfaces 9.

As shown in FIG. 2, the support elements 10 are preferably arranged so as to form a free space between them, the free space being sufficient to make the entire height of the container 2 visible. In this way, it is possible for diners around a table to clearly see the cooking of a food item in the container 2, the container 2 preferably being transparent.

The support elements 10 are preferably oriented upwards towards the inside of the appliance, so that the flames resulting from combustion of the combustion liquid 4 can be directed towards the side walls of the container 2. This prevents the flames from bypassing the container 2 and losing too much of the heat they produce.

The reservoir 3 is preferably wider than it is deep. Thus, when combustion of the combustion liquid 4 is triggered, the surface area ignited is relatively large compared with the quantity of liquid 4 in the reservoir. This enables heat to be generated over a larger surface area, promoting more even cooking of the food 1 located in the container 2.

In the preferred embodiment shown in FIG. 1, reservoir 3 features a protrusion 11. The protrusion 11 can be used as a marker for filling the reservoir 3 with combustion liquid 4. This makes it easy to dose a given volume of combustion liquid 4, e.g. 5 ml, by simply pouring in the combustion liquid precisely until the protrusion 11 is covered by the combustion liquid.

The reservoir 3 can be connected to the holding support 5 by at least one arm 12. As shown in FIG. 2, the device can have two arms 12, giving it greater stability. However, one arm 12 is sufficient, and may be preferred, for example, for aesthetic reasons. Arm 12 can be fitted with a chute 13, the bottom of which is inclined towards reservoir 3. Thus, when combustion liquid 4 is poured into the end of chute 13 furthest from reservoir 3 (distal end), the combustion liquid 4 flows naturally to reservoir 3. This makes it possible to place combustion liquid 4 in reservoir 3 when access to reservoir 3 is difficult, for example due to the presence of container 2.

The combustion liquid 4 used in the present invention can be ethanol with a percentage of between 85% and 99%. This range ensures that the ethanol ignites and burns completely, and also avoids expensive ethanol production processes aimed at removing the last percent of water. This ethanol preferably contains a Hydroxy-Alkyl-Cellulose, for example a Hydroxy-Propyl-Methyl-Cellulose, to increase the viscosity of the combustion liquid 4, the dosage of Hydroxy-Alkyl-Cellulose being limited so as to obtain a dynamic viscosity of less than 100 Pa-s, and so that the ethanol is always liquid. Combustion liquid 4 can then be easily and uniformly deposited in reservoir 3, without the risk of splashing.

This also enables the device to be moved safely. For example, a device according to the invention can be used to serve customers in a restaurant. You can then choose to ignite the combustion liquid 4 in the kitchen, and bring it to the table ignited. With its increased viscosity, the ethanol does not risk spilling, and safety is assured.

The device according to the invention can be used to cook or heat a food according to a process comprising the following steps:
placing a food item 1 in the container 2,
placing the container 2 on the holding support 5, if necessary by pressing the shoulder 8 of the container 2 onto a bearing surface 9 of the holding support 5,
combustion liquid is poured into the reservoir, if necessary via a chute 13,
these first three steps being carried out in any order,
ignition of the combustion liquid,
cooking or heating food.

For example, cooking an egg in the container may take between 3 and 5 minutes. The guest or customer can then preferably observe the cooking progress thanks to the transparency of the container 2 and the space kept free between two support elements 10.

When the flame goes out, you may choose to wait a few more minutes before tasting. In this case, the heat stored in the bottom and sides of the container continues to transfer to the food, and the egg, for example, may become a little harder.

The result is a show effect that can contribute to the atmosphere created around a meal enjoyed by many.

For example, the process described above can be used to prepare a “œuf parfait” or “œuf cocotte”.

You can also make poached oysters on leek fondue.

You can also prepare a chocolate mi-cuit or moelleux.

You can still prepare an Irish coffee, served at a bar by a bartender.

Although the above description is based on particular embodiments, it is by no means limitative of the scope of the invention, and modifications may be made, in particular by substitution of technical equivalents or by different combination of all or some of the features developed above.

1. An apparatus for cooking or heating food, the appliance comprising a container designed to receive said food, a reservoir disposed beneath said container and suitable for receiving a combustion liquid, and a holding support for holding said container and reservoir, said container comprising a bottom and at least one side wall, the appliance being characterized in that the thickness of the bottom measured at the center of the bottom is at least twice as great as the smallest thickness measured on the wall.

2. Apparatus according to claim 1, in which the thickness of the bottom measured at the center of the bottom is greater than or equal to 6 mm, typically equal to 9 mm, and the smallest thickness measured on the wall is between 2 and 4 mm, typically equal to 3 mm.

3. Apparatus according to claim 1, wherein said container comprises at least one shoulder, and said holding support comprises at least one bearing surface of at least one of said at least one shoulder.

4. Apparatus according to claim 3, wherein said holding support comprises at least two upwardly extending support elements, each support element comprising at least one of said at least one bearing surface, said holding support comprising a free space between the two support elements configured so as to render said container visible over its entire height, the container preferably being transparent.

5. Apparatus according to claim 4, in which said at least two support elements are inclined upwards towards the interior of the device.

6. Apparatus according to claim 1, in which the reservoir is wider than it is deep.

7. Apparatus according to claim 1, in which the reservoir has a protuberance extending upwards from the bottom of the reservoir.

8. Apparatus according to claim 1, in which the reservoir is fixed to the holding support by at least one arm, and at least one of said at least one arms comprises a chute whose bottom is inclined towards the reservoir.

9. Apparatus according to claim 1, in which said combustion liquid is an ethanol with a percentage of between 85% and 99%, said ethanol comprising a Hydroxy-Alkyl-Cellulose, the dosage of Hydroxy-Alkyl-Cellulose being limited so as to obtain a dynamic viscosity of less than 100 Pa-s.

10. A method of cooking or heating a foodstuff by means of an appliance according to claim 1, comprising the following steps:
placing a food item in the container,
positioning the container on the retaining bracket,
pouring a combustion liquid into the reservoir,
these first three steps being carried out in any order,
ignition of the combustion liquid,
cooking or heating food.
